(19) United States
(12) Patent Application Publication
(10) Pub. No.: US 2007/0279954 A1
(43) Pub. Date: Dec. 6, 2007

(54) Device For Converting AC Power To Multiple DC Outputs With Retractable Cords And Multiple Adapter Tips

(76) Inventors: Michael C. Garrett, Wilmette, IL (US); Kristina J. Genslak, St. Joseph, MI (US); Matthew N. Christensen, Stevensville, MI (US); Samuel K. Miller, Bristol, IN (US); Christopher D. Hekel, Plainfield, IL (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/757,832

(22) Filed: Jun. 4, 2007

Related U.S. Application Data
(60) Provisional application No. 60/810,833, filed on Jun. 5, 2006.

(51) Int. Cl. H02M 7/04; H02M 5/42

(52) U.S. Cl. 363/91

(57) ABSTRACT

An electrical adapter is disclosed that includes a power supply circuit, a sensing circuit and one or more universal DC output connectors. The electrical adapter is configured to convert AC input power at a nominal 120 volts AC to one or more DC output voltages which has the ability to provide different nominal DC voltages to each universal DC output connector depending on the portable DC device connected thereto. The electrical adapter includes a device sensing circuit that automatically senses when a portable DC device is connected to or disconnected from any of the universal DC output connectors. The electrical adapter also includes a voltage and current sensing circuit that monitors the voltage and current applied to the portable DC device connected to the universal DC connector that is used to provide closed loop feedback to the power supply circuit in order to adjust the voltage applied to the universal DC output connector as a function of the voltage and current requirements of the portable DC device connected thereto. As such, each universal DC output connector can be used for portable DC devices having different nominal DC requirements. For example, an electrical adapter with four universal DC output connectors can be used to power four cell phones with nominal 5 volt DC requirements. The same universal DC connectors can alternatively be used to charge four laptop computers with a nominal 15 volt DC requirement or any combination thereof with no changes of the circuitry required. The electrical adapter in accordance with the present invention provides significantly more flexibility than known electrical adapters in which each connector has a dedicated output voltage.

### CROSS REFERENCE TO RELATED APPLICATIONS

This application claims the benefit of and priority to U.S. Provisional Patent Application No. 60/810,833, filed Jun. 5, 2006, hereby incorporated by reference.

### BACKGROUND OF THE INVENTION

1. Field of the Invention

The present invention relates to an electrical device and more particularly to an electrical adapter that converts AC power to at least one DC output voltage that is applied to at least one universal DC output connector, the electrical adapter being configured to sense the DC voltage and current requirements of portable DC devices connected thereto and provide different nominal DC voltages to each universal DC output connector as a function of the voltage and current requirements of the device connected thereto.

2. Description of the Prior Art

Various electrical adapters are known in the art. Examples of such electrical adapters are disclosed in U.S. Pat. Nos. 6,402,546; 6,486,407; 6,879,497; 6,881,069; and 6,994,592, hereby incorporated by reference. Exemplary electrical adapters are also disclosed in US Patent Application Publication Nos.: US 2002/0075711 A1; US 2002/0154528 A1; US 2003/0082952 A; US 2004/0120168 A1; and US 2007/0091656 A1, as well as International Patent Application Publication Nos. WO 01/08262; WO 07/043,250; WO 07/047,453 and Korean Patent Publication No. KR 2005/0018706, all hereby incorporated by reference.

In general, such electrical adapters are used to provide a DC power supply to portable battery operated devices, such as lap top computers, cell phones, as well as other portable battery operated devices. Such devices are normally configured with an AC plug to enable the adapter to be plugged into a standard 120 volt AC wall receptacle. These electrical adapters normally include a step down transformer for stepping down the 120 volt AC voltage to a lower value suitable for portable battery operated devices, as well as a rectifier for converting the AC input voltage to one or more DC voltages and a DC regulator for providing one or more DC output voltages. The DC output voltage is normally connected to one or more connectors, configured to be plugged into one or more portable DC devices.

Portable battery operated devices operate at various DC voltages. For example, some known laptop computers operate at 15 volts DC, while some known cell phones and personal digital assistants (PDA) are known to operate at 5 volts DC. As such, the nominal (i.e. steady state) DC output voltages applied to each connector of such electrical adapters is generally fixed. In other words, each DC connector can only be used at a single DC nominal voltage. For example, connectors normally connected to a nominal 15 volts DC can not be used for portable battery operated devices that require a nominal 5 volts DC. As such, the utility of such electrical adapters is rather limited.

U.S. Pat. No. 6,994,592 purports to be able to control the voltage tolerance of an adapter with an integral battery charger. In particular, the '592 is able to provide a wider range of voltage tolerances so that the power supply within the electrical adapter can operate with a wider range of devices having different surge voltages. Even though, the '592 patent discloses a system for providing additional flexibility, each DC output connector is still limited to a single nominal voltage.

Thus, there is a need to provide an electrical adapter that has greater flexibility that known adapters that can provide different nominal output voltages to each electrical connector as a function of the device connected thereto.

### SUMMARY OF THE INVENTION

The present invention relates to an electrical adapter that includes a power supply circuit, a device sensing circuit, a voltage and current sensing circuit and one or more universal DC output connectors. The electrical adapter is configured to convert AC input power at a nominal 120 volts AC to one or more DC output voltages which has the ability to provide different nominal DC voltages to each universal DC output connector depending on the portable DC device connected thereto. The device sensing circuit automatically senses when a portable DC device is connected to or disconnected from any of the universal DC output connectors. The voltage and current sensing circuit monitors the voltage and current applied to the portable DC device, connected to the universal DC connector The monitored voltage is used to provide closed loop feedback to the power supply circuit in order to adjust the voltage applied to the universal DC output connector as a function of the voltage and current requirements of the portable DC device connected thereto. As such, each universal DC output connector can be used for portable DC devices having different nominal DC requirements. For example, an electrical adapter with four universal DC output connectors can be used to power four cell phones with nominal 5 volt DC requirements. The same universal DC connectors can alternatively be used to charge four laptop computers with a nominal 15 volt DC requirement or any combination thereof with no changes of the circuitry required. The electrical adapter in accordance with the present invention provides significantly more flexibility than known electrical adapters in which each connector has a dedicated output voltage.

### DESCRIPTION OF THE DRAWING

These and other advantages of the present invention will be readily understood with reference to the following specification and attached drawing wherein:

FIG. 1 is an exemplary block diagram of an electrical adapter in accordance with the present invention illustrating a single universal DC output connector for use with a single portable DC operated device, such as a laptop computer.

FIG. 2 is a more detailed block diagram of the electrical adapter illustrated in FIG. 1, illustrating multiple universal DC output connectors for use with multiple portable DC devices, such as laptop computers and a sensing circuit for sensing the voltage and current requirements of the various portable DC devices connected to the universal DC output connectors.

FIG. 3 is a timing diagram illustrating the voltage applied to a universal DC output connector as a function of time for an exemplary portable DC device connected thereto.

FIG. 4 is a block diagram of a power supply circuit configured in a feedback loop which automatically adjusts the DC voltage applied to the universal DC output connector as a function of the voltage and current requirements of the portable DC device connected thereto.

FIG. 5 is flow chart for the electrical adapter in accordance with the present invention.

### DETAILED DESCRIPTION

The present invention relates to an electrical adapter that includes a power supply circuit, a device sensing circuit, a voltage and current sensing circuit and one or more universal DC output connectors. The electrical adapter is configured to convert AC input power at a nominal 120 volts AC to one or more DC output voltages which has the ability to provide different nominal DC voltages to each universal DC output connector depending on the portable DC device connected thereto. The device sensing circuit automatically senses when a portable DC device is connected to or disconnected from any of the universal DC output connectors. The voltage and current sensing circuit monitors the voltage and the current applied to the portable DC device connected to the universal DC connector. The monitored voltage is used to provide closed loop feedback to the power supply circuit in order to adjust the voltage applied to the universal DC output connector as a function of the voltage and current requirements of the portable DC device connected thereto. As such, each universal DC output connector can be used for portable DC devices having different nominal DC requirements. For example, an electrical adapter with four universal DC output connectors can be used to power four cell phones with nominal 5 volt DC requirements. The same universal DC connectors can alternatively be used to charge four laptop computers with a nominal 15 volt DC requirement or any combination thereof with no changes of the circuitry required. The electrical adapter in accordance with the present invention provides significantly more flexibility than known electrical adapters in which each connector has a dedicated output voltage. The electrical adapter in accordance with the present invention provides significantly more flexibility than known electrical adapters in which each connector has a dedicated output voltage.

Referring first to FIG. 2, an exemplary configuration of an electrical adapter is illustrated and generally identified with the reference numeral 20. As shown, the electrical adapter 20 is provided with two exemplary universal DC output connector manifolds 22, 24. Each manifold 22,24 may be connected to a plurality of connectors 44, device sensing circuits 28 and voltage and current sensing circuits 71. The connectors 44 connected to each manifold 22, 24 are connected to the same switch 34 and may have different configurations for use with different portable DC devices. In one embodiment of the invention, only one connector 44 per manifold 22, 24 is intended to be used at a time.

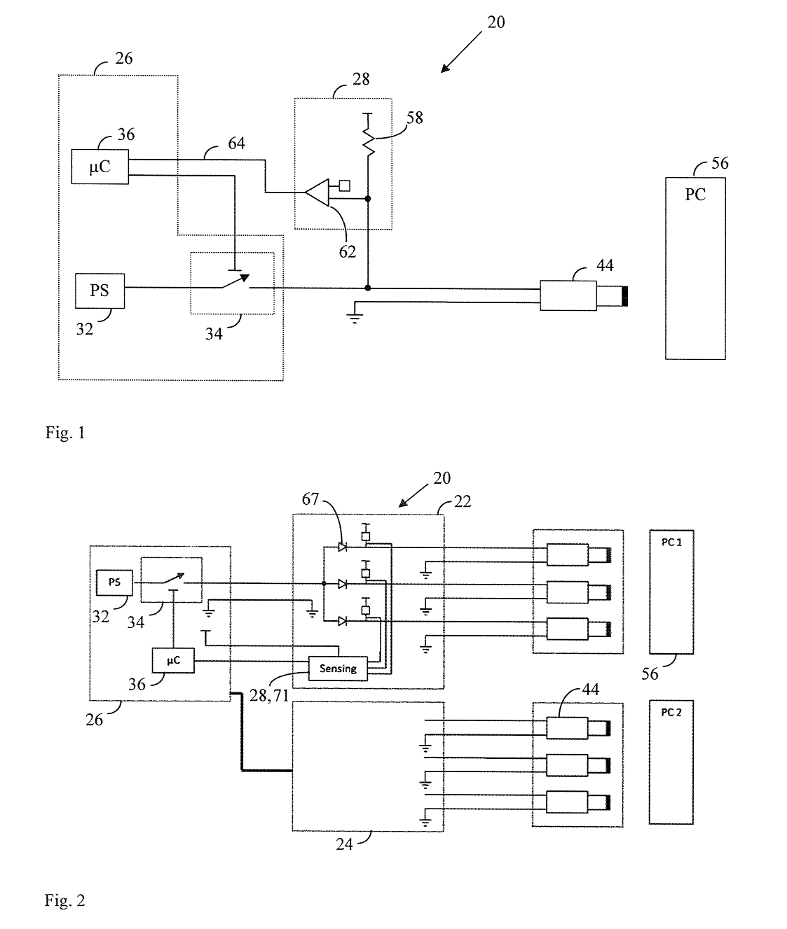

The electrical adapter 20 also includes a power supply circuit 26 and multiple device sensing circuits 28 (FIG. 1) and a voltage and current sensing circuit 71 (FIG. 4). The device sensing circuit 28 is used to sense when a portable DC devices 56 are connected to or disconnected from any of the universal DC output connectors 44 connected to the universal DC manifold 22. The DC power output to the universal DC connector manifolds 22, 24 is under the control of the power supply circuit 26.

Referring to FIG. 2, the power supply circuit 26 includes an adjustable power supply 32 (FIGS. 2 and 4), for example, a Model No. L6599, as manufactured by ST Microelectronics, a power switch 34, shown as a single pole single throw switch, which may be implemented as a Field Effect Transistor (FET), and a microcontroller 36, for example, a Model No. ADUC7020, as manufactured by Analog Devices, with an on-board digital to analog converter 38 (FIG. 4) and an on-board analog to digital converter 40. The power supply circuit 26 includes a step down transformer, a rectifier and a DC converter for converting a nominal 120 volts AC to one or more DC voltages. In configurations of the electrical adapter 20, as shown, with multiple universal DC manifolds 22, 24, an additional power supply circuit (not shown) may be provided which includes a separate power switch and a separate adjustable power supply for controlling the output DC to the universal DC manifold 24.

Referring to FIG. 1, the electrical adapter 20 is illustrated in more detail. For simplicity, the electrical adapter 20 is shown with a single universal DC output connector 44. As mentioned above, the electrical adapter 20 also includes a device sensing circuit 28 and a power supply circuit 26 which includes an adjustable power supply, a single pole, single throw switch 34 and a microcontroller 36. One pole of the switch 34 is connected to, for example, a positive terminal (not shown) on the universal DC output connector 44. The negative terminal of the universal DC output connector 44 is connected to system ground for negative grounded DC applications.

The switch 34 is under the control of the microcontroller 36. When the switch 34 is closed, DC electrical power from the adjustable power supply 32 is connected to the universal DC output connector 44. When the switch 52 is open, the adjustable power supply 32 is disconnected from the universal DC connector 44.

As will be discussed in more detail below, the voltage and current sensing circuit 71 (FIG. 4) senses the DC electrical power, i.e. electrical voltage and power, supplied to the universal DC output connector 44 when it is connected to a portable DC device, such as the laptop computer 56, illustrated. The voltage and current sensing circuit 71 forms a closed feedback loop with the adjustable power supply 32 and provides a DC voltage to the universal DC connector 44 as a function of the DC power requirements of the portable DC device 56 connected thereto. More particularly, the microcontroller 36 monitors the current and voltage applied to the DC output connector 44 and causes the adjustable power supply 32 to adjust its output voltage, as discussed in more detail below. The adjustable DC supply 32 can provide various DC voltages, for example from 5 volts DC to 24 volts DC to the universal DC connector 44, while controlling and monitoring the voltage and current that can be delivered by the power supply 32. For example, the same universal DC connector 44 can be used for charging a cell phone (not shown) at a nominal 5 volts DC. After, the cell phone is disconnected, the same universal DC connector 44 can be used to charge a laptop computer at a nominal 15 volts DC. In configurations of the electrical adapter 42 with multiple universal DC connectors, one universal DC connector 44 can be used for charging a cell phone at a nominal 5 volts DC and another universal DC connector can be used for charging a laptop computer at a nominal 15 volts DC, even though the circuitry for each universal DC connector is the same.

As mentioned above, the electrical adapter 20 also includes a device sensing circuit 28 that is best illustrated in FIG. 1. The device sensing circuit includes a pull-up resistor 58, a comparator 62 which communicates with the microcontroller 36 with and the adjustable power supply 32. For simplicity, the operation of a electrical adapter 42 with a single universal DC output connector 44, device sensing circuit 28 and power supply circuit 48 is described. Electrical adapters with multiple universal DC connectors 44, device sensing circuits 28 and power supply circuits 48 operate in essentially the same manner.

Referring to FIGS. 1 and 4, if no portable DC devices 56 are connected to the universal DC output connector 44, the pull-up resistor 58 pulls up the negative input of the comparator 62 to a level higher than the reference voltage applied to the positive input causing the comparator 62 to output a logical “0”, for example, 0 volts DC. The output of the comparator 62 may be applied to the analog to digital converter 40 (FIG. 4) or directly to an input port on the microcontroller 36 on line 64. On power-up or in response to a portable DC device 56 being disconnected, the microcontroller 36 issues a signal along line 66 to the switch 34 that causes the switch 34 to open. When a portable DC device 56 is connected to the universal DC output connector 44, the voltage at the negative input of the comparator 62 is pulled down by the low impedance of the portable DC device 56 connected to the universal DC connector 44. As a result, the comparator output on line 64 changes state to a logical “1”, thereby notifying the microcontroller 36 that a connection has been made.

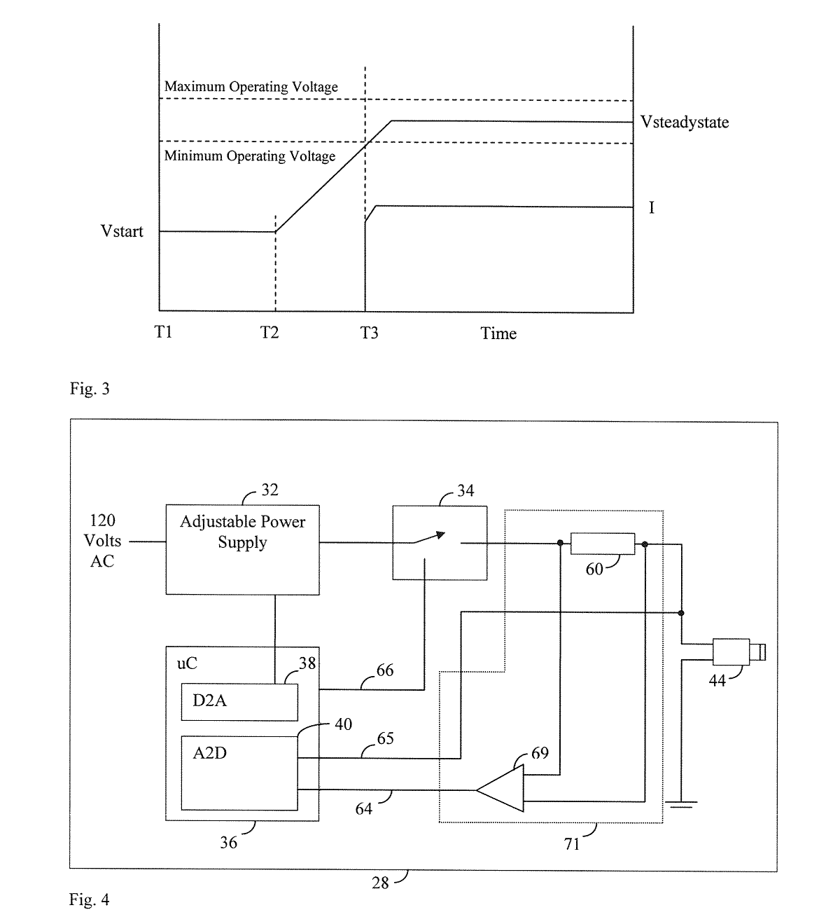

In accordance with an important aspect of the invention, once the microcontroller 36 determines that a portable DC device 56 has been connected to one of the universal DC output connectors 44, the voltage and current sensing circuit 71 (FIG. 4) automatically monitors and determines the voltage and current requirements of the portable DC device 56 connected to the universal DC output connector 44. In particular, with reference to FIG. 4, once the microcontroller 36 senses that a portable DC device has been connected to the universal DC output connector 44, at time T1 (FIG. 3), for example, the microcontroller 36 closes the switch 34 by way of a signal on line 66 (FIG. 4). Between time T1 and time T2, the microcontroller 36 sets the operating voltage of the adjustable power supply 32 to a relatively low voltage level Vstart, estimated to be lower than the required operating voltage of any of the portable DC devices 56 that are anticipated to be connected to the universal DC connector 44.

The present invention takes advantage of modern power supply design circuitry which typically contains circuitry for performing under voltage and over voltage lockout of the incoming supply in order to protect the circuitry. This protection mechanism is utilized in the present invention to determine the Minimum Operating Voltage of the adjustable power supply 32 More particularly, modern switching power supply controllers contain a start up circuit that hold off turning on the power supply, when the applied voltage to the supply is lower than or approximately lower than a minimum. Once the applied voltage reaches this point, the startup circuits in the power supply controller start to draw current which is monitored by the current sensing circuitry. Characteristics of this current draw such as its dv/dt are monitored. When using current dv/dt as the parameter in which voltage will be decided, the voltage is raised to the point where the current dv/dt has falling below a steady state point and the voltage is set.

At time T2 (FIG. 3), the microcontroller 36 causes the adjustable power supply 32 to ramp up the voltage to the connected portable DC device 56 from the initial voltage Vstart, for example, in a linear fashion, as shown in FIG. 3 and monitor the load current that the portable DC device 56 draws. The load current is monitored by way of the voltage and current sensing circuit 71 (FIG. 4), serially connected to the universal DC output connector 44. The voltage and current sensing circuit 71 includes a current sensing resistor 60 and a differential amplifier 69. The voltage and current sensing circuit 71 also includes a connection along line 65 between the universal DC output connector 44 and the analog to DC converter 40 on the microcontroller 36. This line 65 allows the microcontroller 36 to monitor the voltage applied to the universal DC output connector 44.

The voltage drop across the current sensing resistor 60 is applied across the input terminals of the differential amplifier 69. As such, the load current through the current sense resistor 60 causes a proportional voltage drop that is applied to the difference amplifier 62. As mentioned above, the output of the difference amplifier 60 is read by the microcontroller 36 by way of the analog to digital converter 40, on-board the microcontroller 36.

Below the minimum operating voltage, the portable DC device 56 being charged draws low current. As the applied voltage nears the Minimum Operating Voltage (FIG. 3), the current starts to ramp up, or quickly ramps up to some value near the normal current draw, for example as shown at time T3+. The microcontroller 36 monitors the change in current vs voltage over time. When rate of change of the current, i.e. di/dt, drops below a preset level, the microcontroller 36 causes the adjustable power supply 32 to stabilize the applied voltage at a level Vsteadystate at or slightly higher than the voltage at which the current derivative drops below the threshold value.

Referring back to FIG. 2, DC blocking diodes 67 are provided. These blocking diodes 67 are used to enable detection of connections to configurations in which multiple universal DC connectors 44 are connected to a single power switch 34, as illustrated in FIG. 2. More particularly, with such a configuration, during a condition when the switch 34 is closed and a portable DC device 56 is connected to one of the multiple universal DC connectors 44 connected to the switch 34, the blocking diodes 67 are used to enable the system to monitor whether additional portable DC devices 56 are connected to any of the other universal DC connectors 44 connected to the same switch 34, i.e. same manifold. More particularly, when a portable DC device 44 is connected to one of the universal DC connectors 44, the voltage on the cathode side of the blocking diode 67 is low. During such a condition, the switch 34 will be closed causing the voltage on the anode side of the blocking diode 67 to be high causing the blocking diode 67 to conduct.

As mentioned above, the blocking diodes 67 allow other universal DC connectors 44 connected to the same switch 34, as illustrated in FIG. 2, to be monitored. In particular, when only a single portable DC devices 56 is connected to one of many universal DC output connectors, the blocking diodes 67 corresponding to the unconnected universal DC connectors are reversed biased by way of the pull-up resistor 58 which pulls up the voltage on the cathode side of these blocking diodes 67 to a value higher than the voltage at the output of the power supply 32, thus causing the blocking diodes 67 to be reverse biased and block power from the power supply 32 to the unconnected universal DC connectors 44. Should a portable DC device 56 be connected to one of the other universal DC output connectors 44 while another portable DC device 56 is connected to one of the other universal DC connectors 44 connected to the same switch 34, the voltage at the cathode of the blocking diode 67 coupled to the latter connected portable DC device 56 drops allowing its blocking diode 67 to conduct and allow the microcontroller 36 to detect the connection in the manner discussed above and enable the microcontroller 36 to immediately open the power switch 34 to prevent damage to the connected portable DC devices 56.

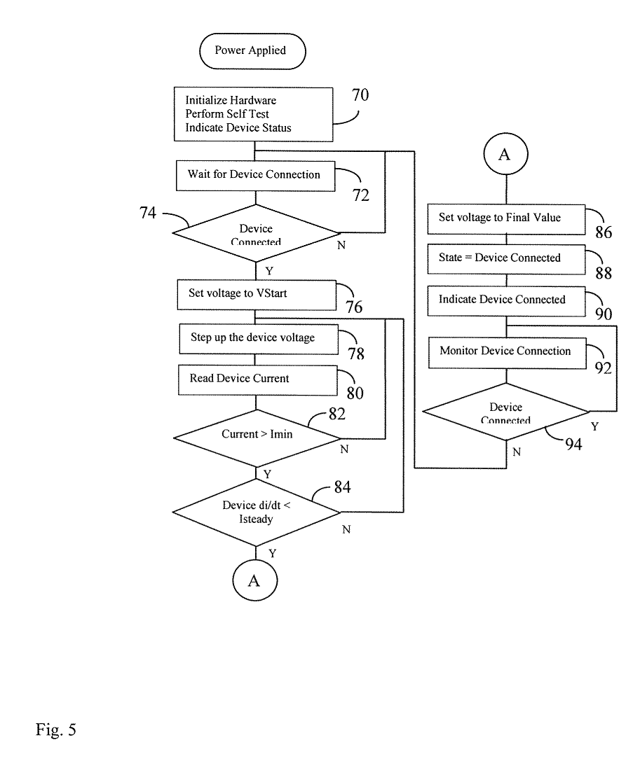

An exemplary software flow chart for the electrical adapter 20 is illustrated in FIG. 5. Initially on power-up, the hardware is initialized and a self-test is performed in step 70. The device status may also be indicated by way of status lights (not shown) or a display (not shown). The system waits for a portable DC device 56 to be plugged into a universal DC connector 44 in steps 72 and 74. Once a portable DC device 56 is connected to a universal DC connector 44 in a manner as discussed above, the microcontroller 36 causes the switch 34 to close and causes the adjustable power supply 32 to output a voltage Vstart (FIG. 3) in step 76 for the time period between T2 and T1 Next in step 78 (FIG. 5), the microcontroller 36 causes the adjustable power supply 32 to ramp up the voltage applied to the universal DC connector 44 starting at time period T2. While the DC voltage is being ramped up, the electrical current drawn by the portable DC device 56 connected to the universal DC connector 44 is measured in the manner discussed above, as indicated in step 80, until the current is greater than a predetermined minimum current Imin, for example, 200 milliamps in step 82. When the current drawn by the portable DC device 56 exceeds Imin, the system checks the rate of change of current per unit of time, di/dt in step 84 as the voltage continues to be ramped up. When di/dt falls below Isteadystate, for example, 100 ma/mSec, the microcontroller 36 causes the adjustable power supply 32 to set the voltage a final value Vsteadystate in step 86. Next in steps 88 and 90, the system stores the state of the device connection and optionally provides an indication that a device is connected. The system continues to monitor the connection of the portable DC device 56 in steps 92 and 94. Once the DC device 56 is disconnected, the system returns step 72 and awaits a device connection.

Other algorithms can also be used to control the output voltage of the adjustable power supply 32. For example, rate of change of voltage with respect to time dv/dt as well as the rate of change of current with respect to voltage, dv/di or di/dv can also be used to control the output voltage of the adjustable power supply 32. In these embodiments, the voltage delivered to the universal DC connector 44 is continuously monitored along line 65, as discussed above. When the value of dv/dt, dv/di or di/dv reaches a predetermined level, the voltage measured along line 65 at that point is used to adjust the steady state output of the adjustable power supply 32 to that level.

The voltage required by the portable DC device 56 once set, will not change between a powered down, or charging state, and an operational state. The current may increase, but the voltage as detected using the method described above, will identify the correct operating voltage at device connection. During operation, the device current is monitored. If the device current demand increases above the maximum current that the device is programmed to deliver for a particular output, for example, 2 amps, the power supply voltage will fall back due to current folding. The microcontroller 36 monitoring this voltage will cause the power supply 32 to increase the current applied to that output to the maximum current. Alternatively, during such a condition when the current demand exceeds the maximum current of the power supply 32, the microcontroller 36 may alternatively initiate the voltage sensing process from the beginning, i.e step 76 (FIG. 5).

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

1. An electrical adapter comprising:
a power supply circuit which includes an adjustable power supply, a switch and a microcontroller, for receiving a nominal AC input voltage and converting it to one or more DC voltages;
at least one universal DC connector, coupled to said adjustable power supply by way of said switch;
a device sensing circuit for sensing when a portable DC device is connected to said at least one universal DC connector; and
a voltage and current sensing circuit connected in a closed feedback loop with said power supply circuit for sensing the load current applied to portable DC connector, wherein said microcontroller causes the adjustable power supply to provide a DC output voltage to said universal DC output connector as a function of the current drawn by said portable DC device over a time period.

2. The electrical adapter as recited in claim 1, wherein said output voltage of said adjustable power supply is set to the voltage when the rate of change of current with respect to time exceeds a predetermined value.

3. The electrical adapter as recited in claim 1, wherein said output voltage of said adjustable power supply is set to the voltage when the rate of change of voltage with respect to time exceeds a predetermined value.

4. The electrical adapter as recited in claim 1, wherein said output voltage of said adjustable power supply is set to the voltage when the rate of change of current with respect to voltage exceeds a predetermined value.

5. The electrical adapter as recited in claim 1, wherein said output voltage of said adjustable power supply is set to the voltage when the rate of change of voltage with respect to current exceeds a predetermined value.
